(19) United States
(12) Patent Application Publication
(10) Pub. No.: US 2019/0270375 A1
(43) Pub. Date: Sep. 5, 2019

(54) 3D DRIVE UNITS & SYSTEMS

(71) Applicants: Gregory James NEWELL, Cascais (PT); Filipe CASIMIRO, Raposa (PT)

(72) Inventors: Gregory James NEWELL, Cascais (PT); Filipe CASIMIRO, Raposa (PT)

(21) Appl. No.: 16/501,603

(22) PCT Filed: Nov. 9, 2017
(86) PCT No.: PCT/IB2017/057024

§ 371 Date: May 7, 2019

Related U.S. Application Data
(60) Provisional application No. 62/419,886, filed on Nov. 9, 2016.

(51) Int. Cl. B60K 7/00; B62D 11/04; B62D 63/04; B60G 17/00

(52) U.S. Cl. CPC B60K 7/0007; B62D 11/04; B62D 63/04; B66F 9/063; B60K 2007/0038; B60K 2007/0092; B60G 17/00

(57) ABSTRACT

The present application relates to a modular drive device and its usage in systems for engaging with and moving heavy loads, solving the problems of fitting under low-profile load formats such as standard pallets and carts while still providing sufficient lifting and conveying torque.

A three dimensional drive unit (120) is disclosed, comprising one or more driven wheels mounted into a cylindrical rotating drive assembly (210) that is itself supported, but able to rotate within, a cylindrical non-rotating housing assembly (130), between which is a slip ring assembly (150).

This solution is used for robotic transportation of materials with typical applications including engaging with and moving pallets, paper rolls, cable reels, vehicles, carts, etc.

### TECHNICAL FIELD

The present application relates to devices and systems for engaging with and moving loads in any direction.

### BACKGROUND ART

Autonomously/robotically controlled movers that engage with a wheeled load, such as a cart or trolley, or unwheeled load, such as a skid or pallet, are a relatively new category of product. Their popularity has been increasing in recent years, the driving force behind this automation being seen throughout the manufacturing, warehousing and logistics industries due to pressure to increase cycle times, reduce labor content, reduce errors, etc. The rate of automation has also been made possible by the many recent advancements in motor technologies, navigation sensor technologies and of course the continuing advancements in computer technology generally.

Many brands of autonomous/robotic load movers now exist including products from companies such as Amazon Robotics (previously KIVA Systems), Fetch Robotics Inc. (VirtualConveyor robots), Clearpath Robotics Inc. (OTTO), Motion Controls Robotics Inc. (MCRI), KUKA (Mobile platforms), BMW (Smart Transport Robots), SSI Schaefer (Weasel, AGV 2Move), Mobile Industrial Robots ApS (MiR) and numerous others. Common limitations to these devices however include:—
i) Current robotic movers, using traditional designs, the robotic movers are typically too high to fit under pallets or pallet height carts—so additional loading and unloading equipment is required to lift the cart or pallet up onto the robot platform. The present invention however has an extremely low profile (under 90 mm height) yet has 80 mm diameter drive wheels, so is able to fit with a 10 mm clearance inside a standard, 100 mm clearance EUR pallet.
ii) Current robotic movers are typically of a fixed size, shape and load handling capacity—however customers that use carts and pallets typically have ones that vary in dimensions and in eight. Even “standard” EUR pallets, though all with 100 mm clearance have 6 different “standard” dimensions. The present invention however can morph in size and in shape using telescoping and pivoting linkages between the drive units and more or less can be used to increase or decrease the load carrying capacity.
iii) Current robotic movers are an integrated design of chassis, drive system, sensors, battery packs, controllers, etc. so for most new applications an entirely new design of robotic mover is required. The present invention however separates the drive system, which provides the driving, turning and lifting and lowering all into a compact, modular and low-cost unit that can then be quickly and easily configured into whatever final machine shape or design is required.
iv) Current robotic movers typically have a very high cost per unit and require high volume deployment before they can make commercial sense. The present invention incorporates compact and very low-cost components, making use of mechanical advantages to multiply the torque when needed and using the same motors for both the driving, turning and lifting functions—normally each being separate drive system for each. Further, the structure is designed to be manufactured from low-cost injection molded plastics or extruded aluminum profiles and with the unit size being so small, in turn the amount of material usage is small. The ultimate result is a significantly lower cost drive unit which allows great flexibility in its incorporation into many different configurations of robotic movers for a broader range of potential applications.

### DISCLOSURE OF INVENTION

The devices of the present application are referred to as “Three Dimensional Drive” (3DD) Units as in addition to effecting motion in the ‘X-Y’ plane (on the ground—moving forwards, backwards and turning in any direction), they can also raise up, with a considerable amount of mechanical advantage, to engage with a load that they are going to relocate. Through the rotation of the drive assembly within its own housing, a 3DD generates a vertical lifting force as well, hence the ‘Z’ direction of travel. This allows a 3DD equipped system to travel under a load then lift it off the ground (or apply enough upward force to provide traction to the driven wheels to move the load) then engage with and move the load in any direction on the ground.

These units are also unique due to their very compact size, low manufacture cost, modularity, scalability and versatility. They can be configured into various arrangements or formations, with more or less units able to be combined in different patterns according to an application's requirements. With the ability of the 3DD units to quickly reorient and drive in any direction, configuring them with connections that include telescoping/extending linkages or pivoting linkages allow the machine to “morph” into different shapes and different sizes to engage with loads of different sizes and shapes.

In one such preferred embodiment, a 3DD unit would measure 180 mm diameter×90 mm in height (collapsed) and able to raise to 135 mm in height once fully raised. It would be capable of lifting approx. 1,000 kg of weight and move loads laterally (assuming typical rolling resistance values) of up to 5,000 kg. (In many cases a load is already on wheels and so does not need to be fully lifted to be moved, but an upwards force provides the engagement and control to allow such a small and light drive unit such as the 3DD to move the wheeled load around).

It is anticipated that for most applications, multiple 3DD units will be used together, sometimes in addition to other non-driven wheels or castors, and housed into a single material handling machine. This allows significant weights to be easily reoriented and relocated as necessary. Applications can include moving pallets, paper rolls, cable reels, vehicles, carts, etc.

These and other features, aspects, and advantages of the present invention will become better understood with regard to the following description, and accompanying drawings.

### BRIEF DESCRIPTION OF THE DRAWINGS

Various embodiments of the invention are described below, including and starting with the preferred embodiment followed by alternative embodiments that achieve the same result.

FIG. 1 is a side perspective view of a “dual drive wheel” embodiment of the 3DD unit, with the rotatable drive assembly fully contracted vertically, which lowers the non-rotating drive housing down to provide clearance to travel under the load which is to be moved.

FIG. 2 is the 3DD unit of FIG. 1 in partial section view, with the rotatable drive assembly shown partially extended (mid travel) and the threaded features of the (rotating) drive assembly and the (non-rotating) drive housing visible. By driving the wheels in opposite travel directions (which is the same rotational direction—so both clockwise for example) the drive assembly will be rotated within the drive housing and will cause a vertical displacement between them. Operating the two drive motors at identical speeds will rotate the units about the common center of the drive assembly and its housing, thereby lifting or lowering one relative to the other but without causing any horizontal translation of the overall unit.

FIG. 3 is the 3DD unit of FIG. 1 with the rotatable drive assembly fully extended vertically, which raises the non-rotating drive housing up, effecting a pushing force up on whatever is attached to that housing.

FIGS. 4 and 5 are bottom views of the 3DD unit showing turning. If one motor is driven at a different rotational speed (different rpm) to the other motor, commonly referred to as a differential drive, this will have the effect of reorienting the travel direction of the drive unit, allowing turning to occur.

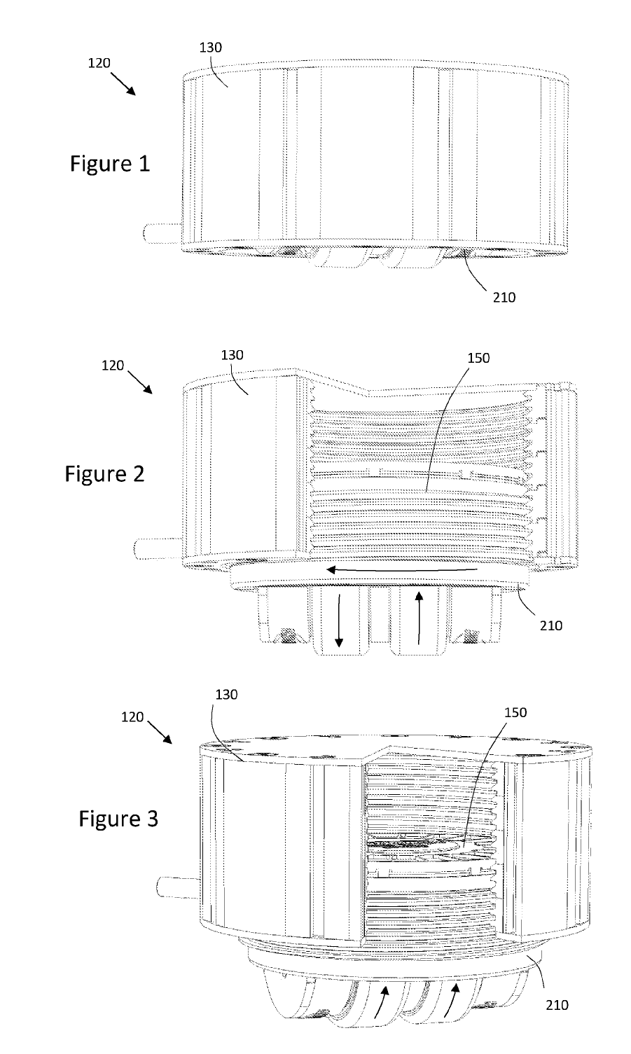

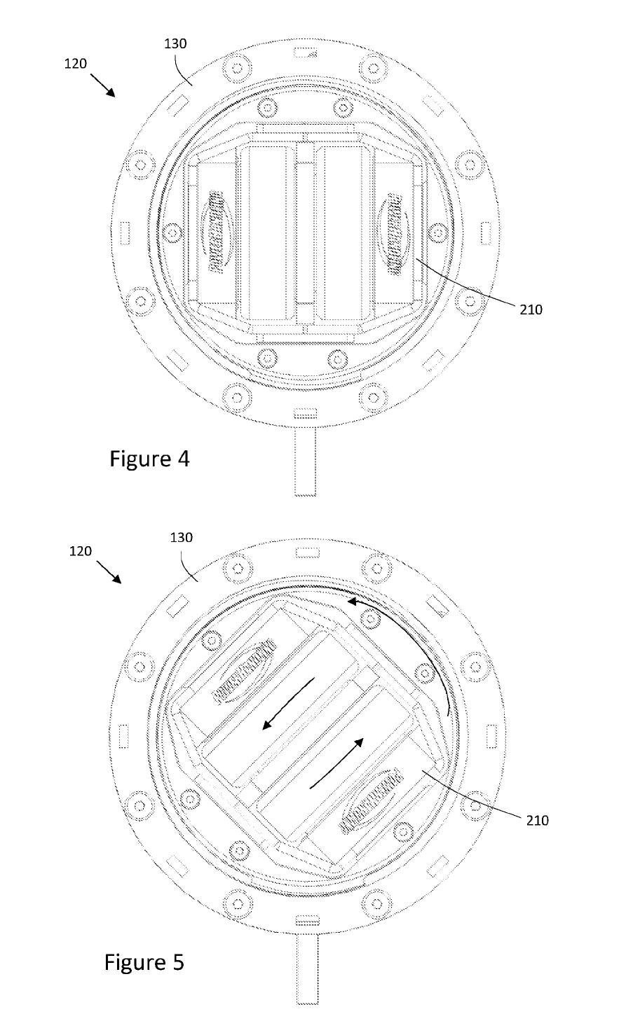

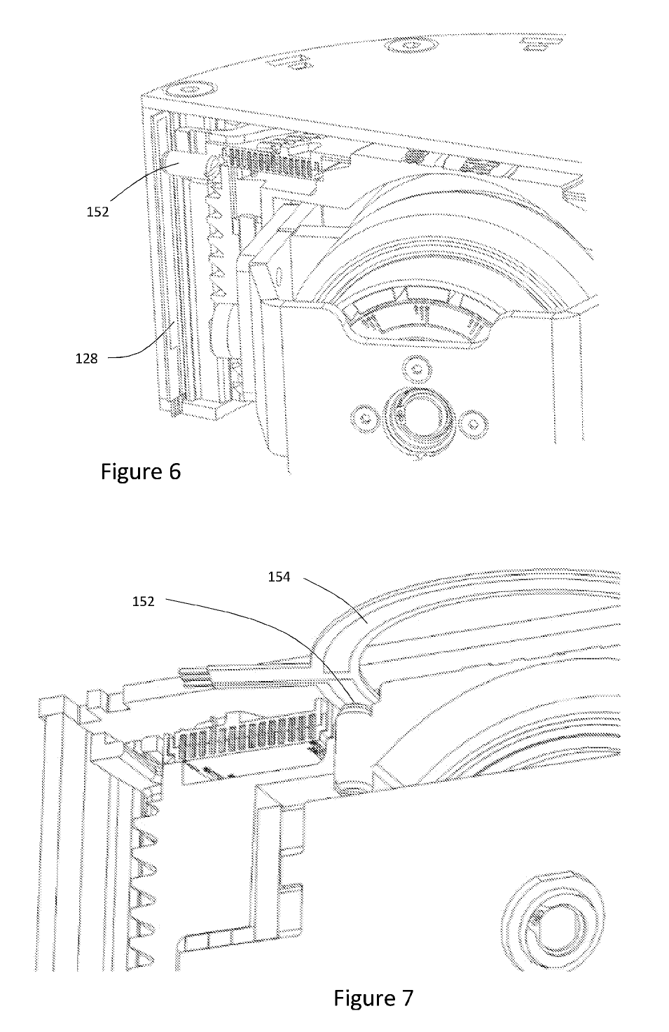

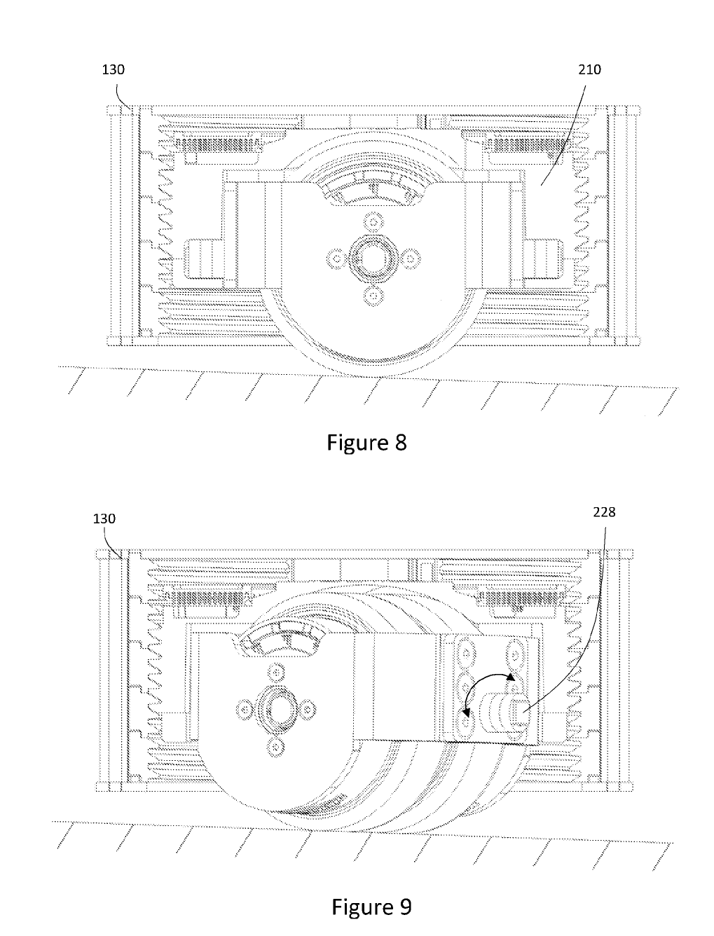

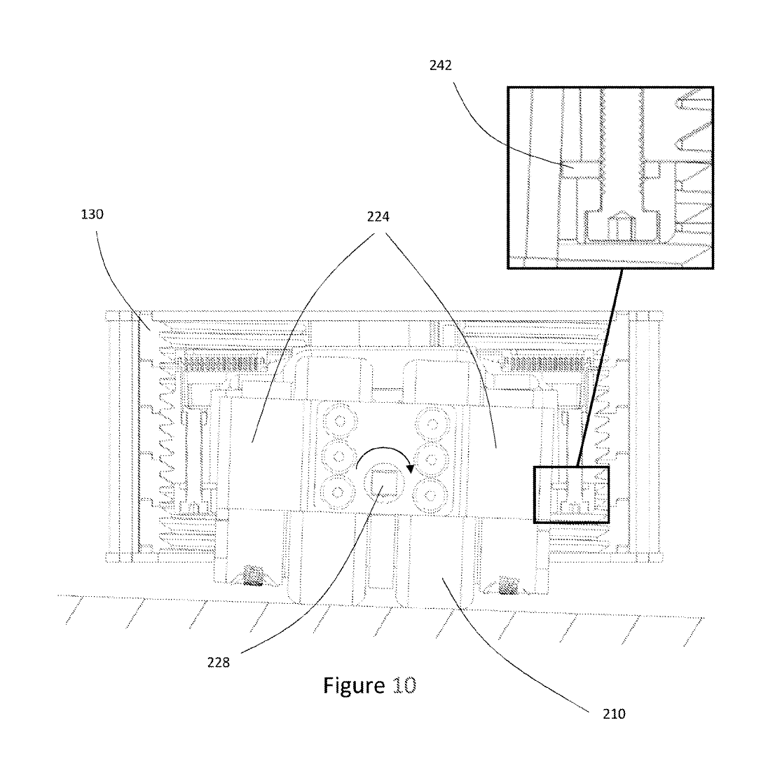

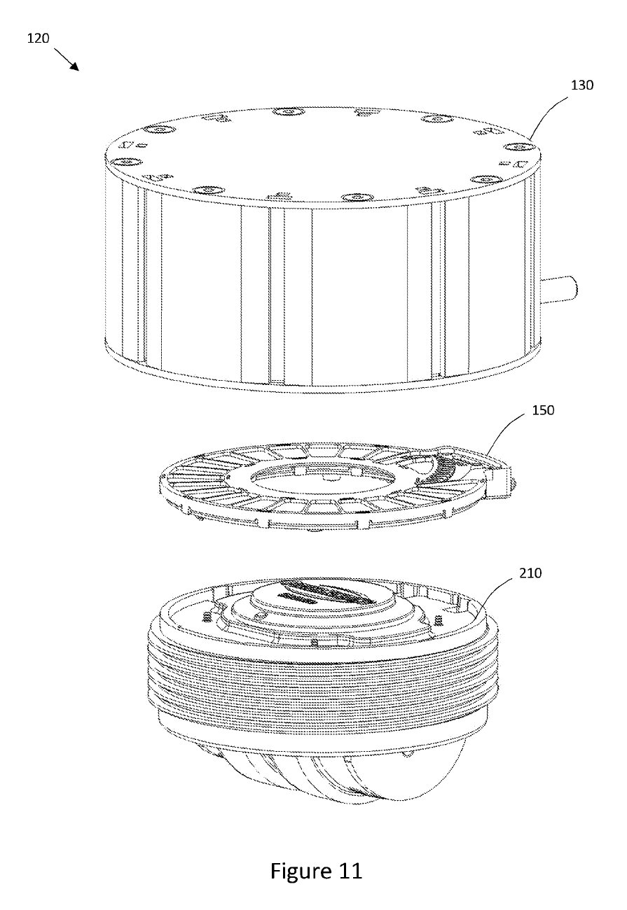

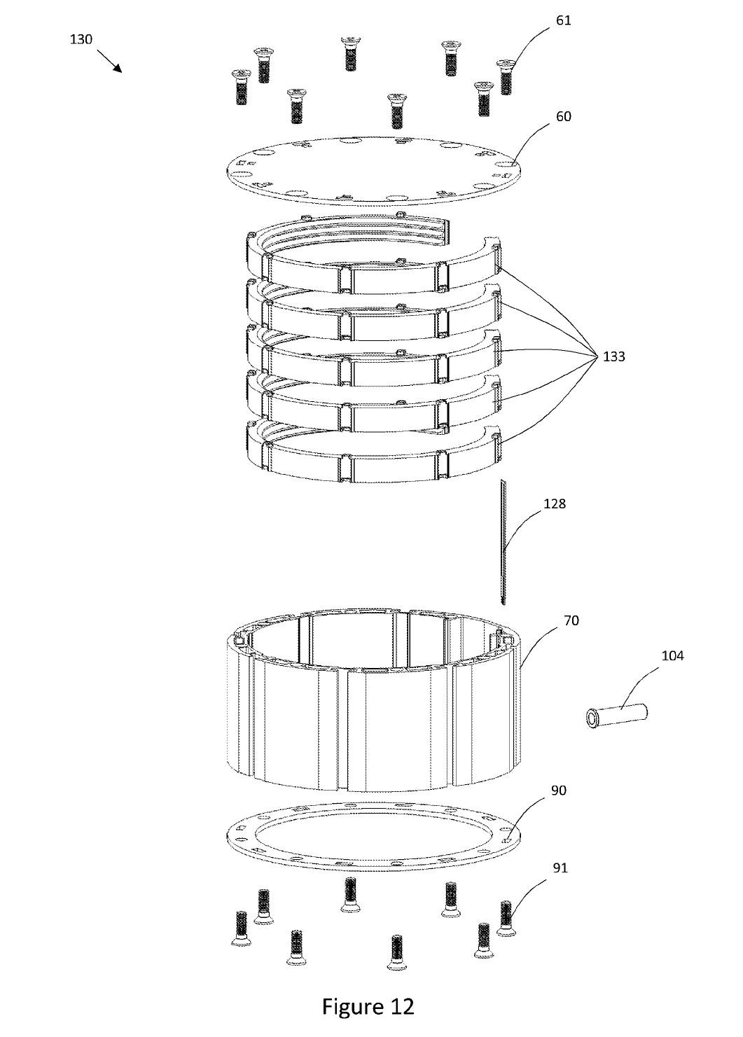

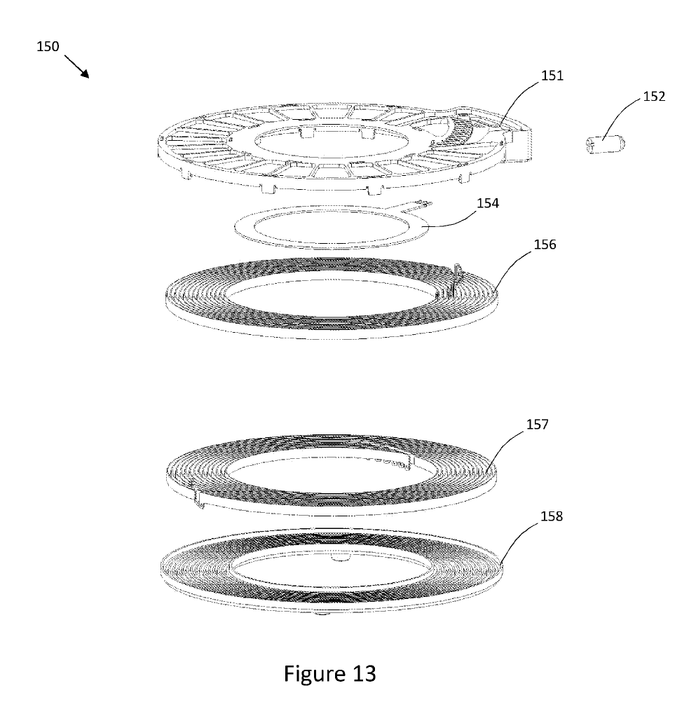

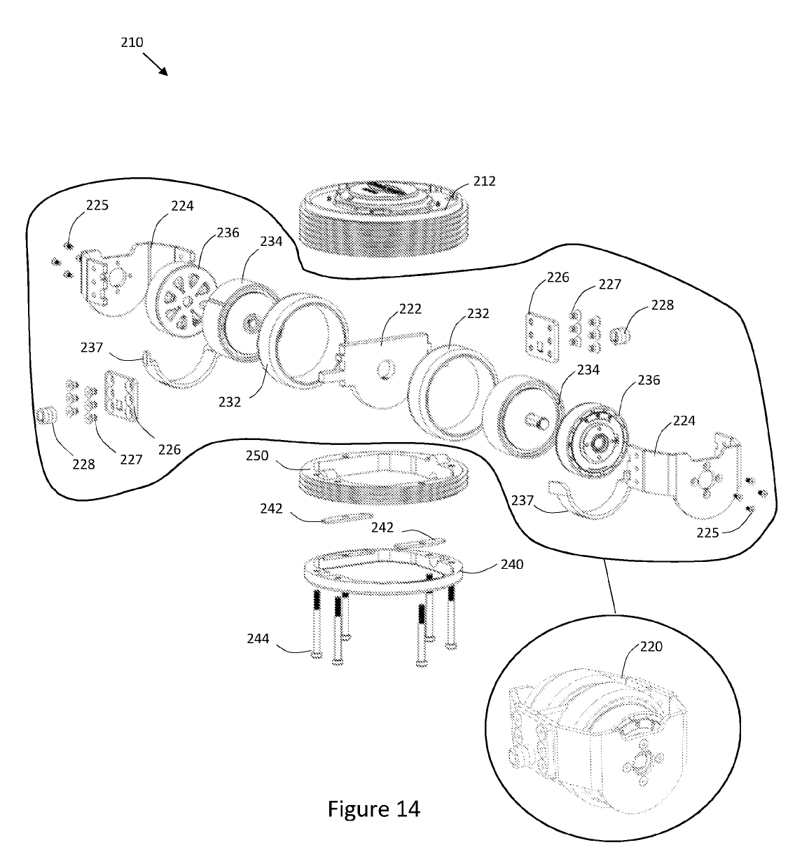

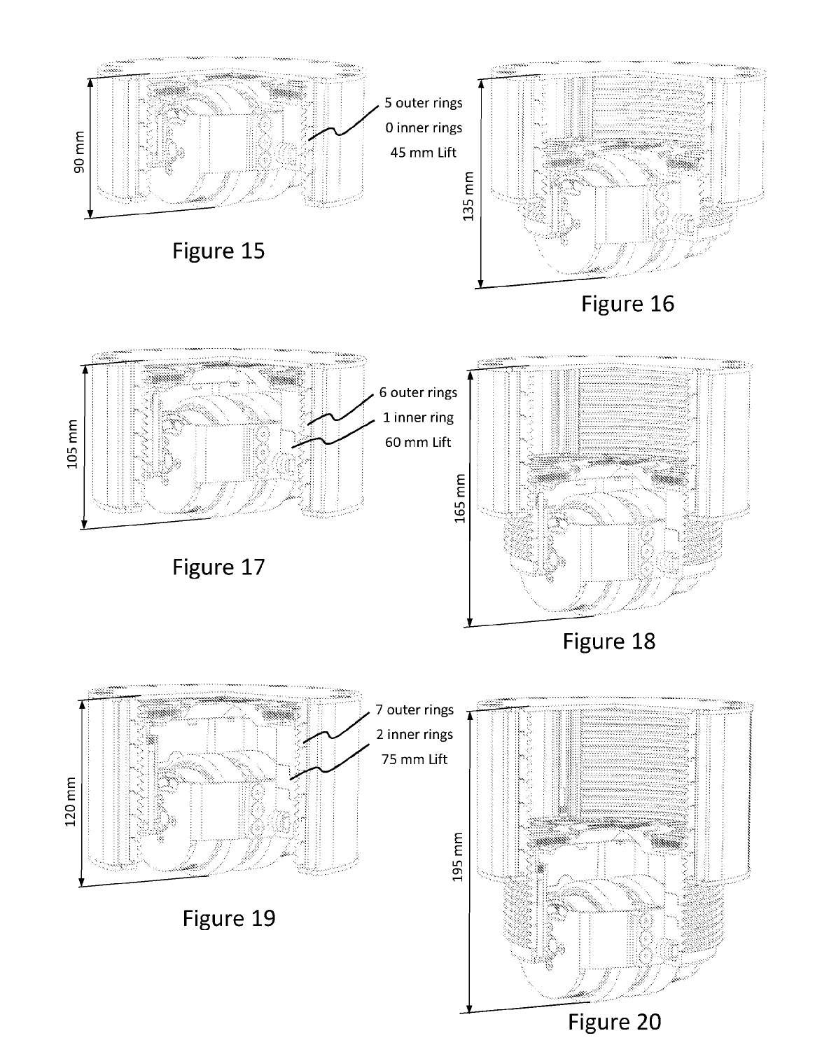

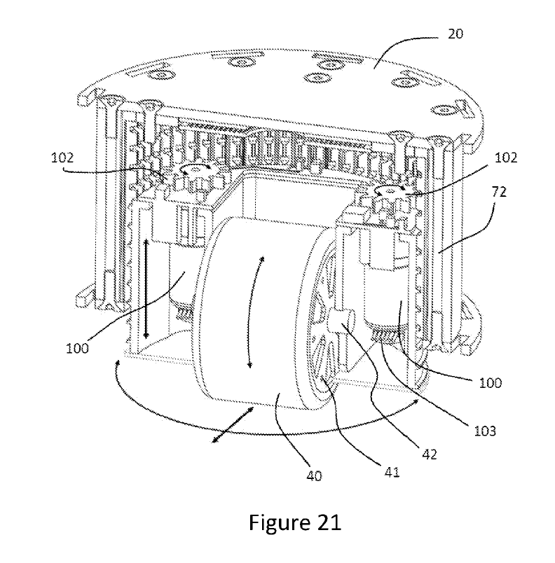

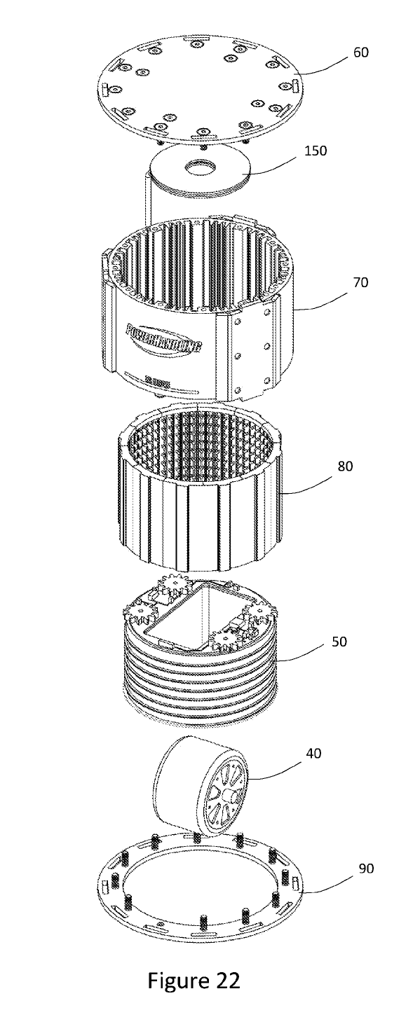

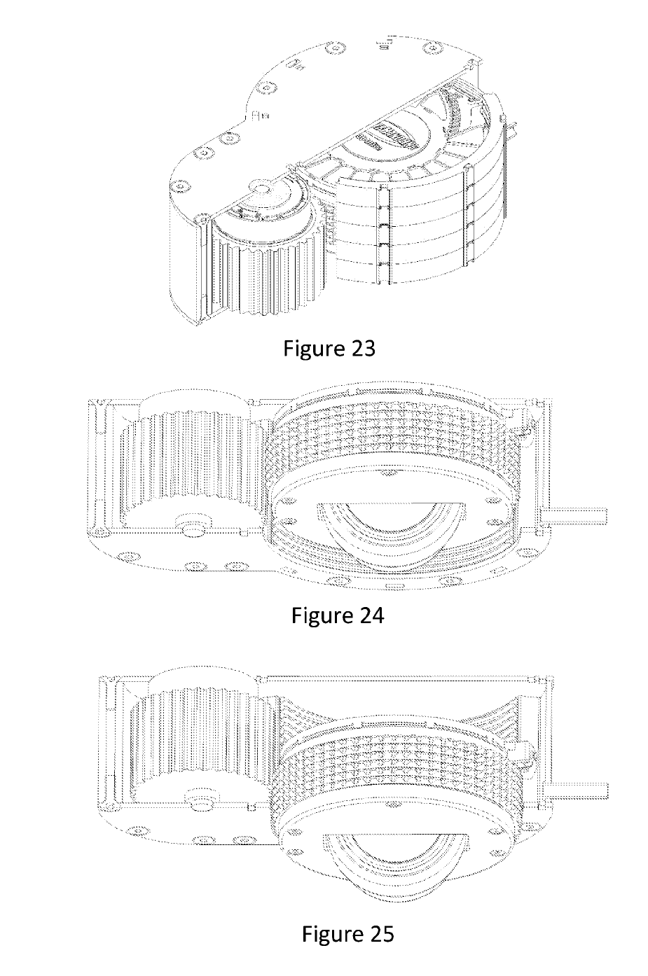

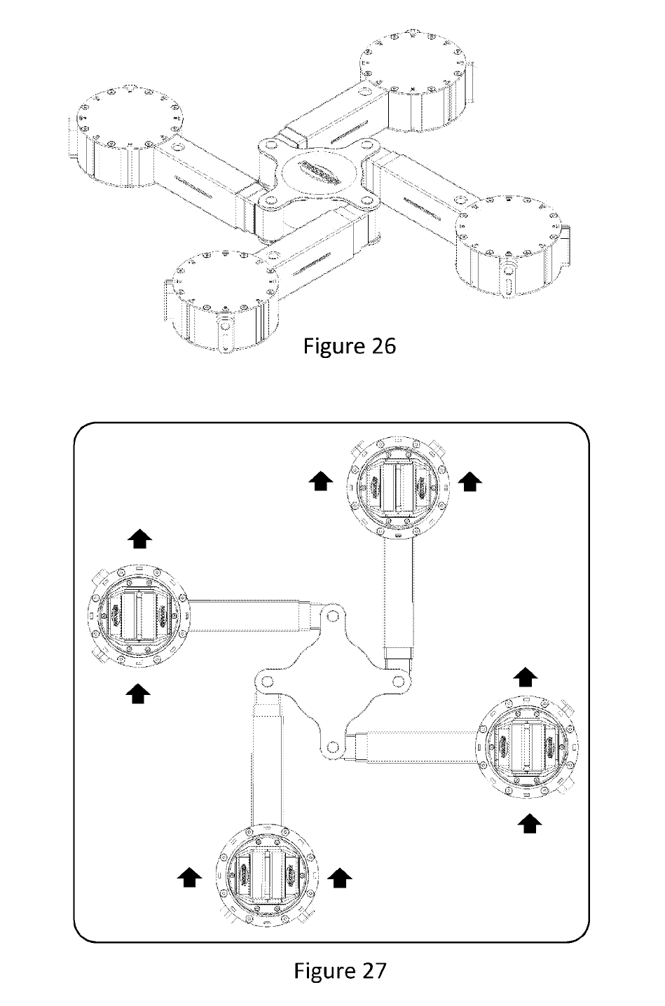

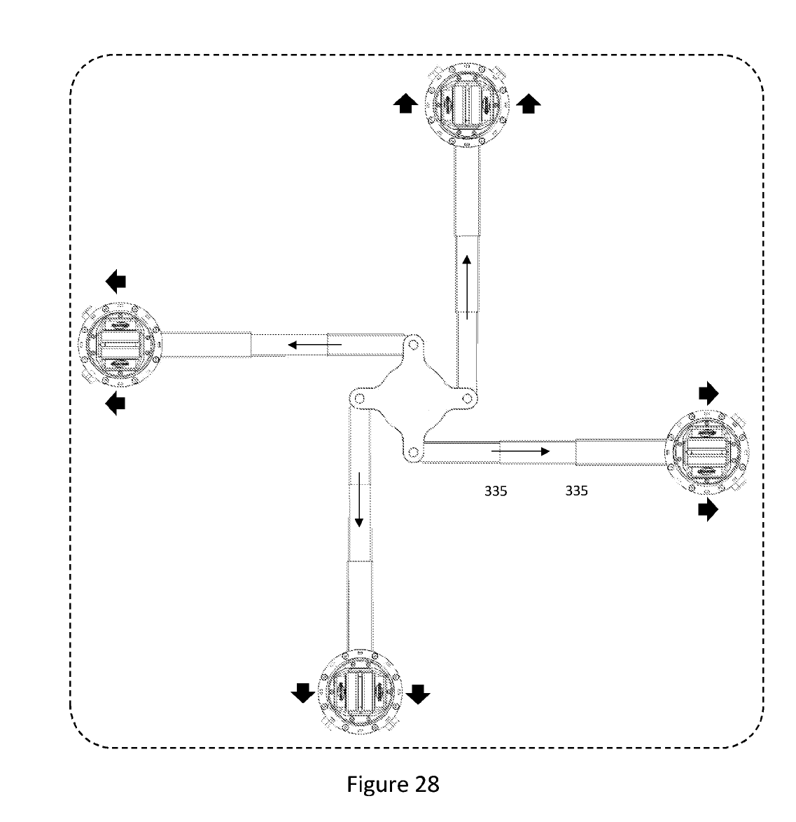

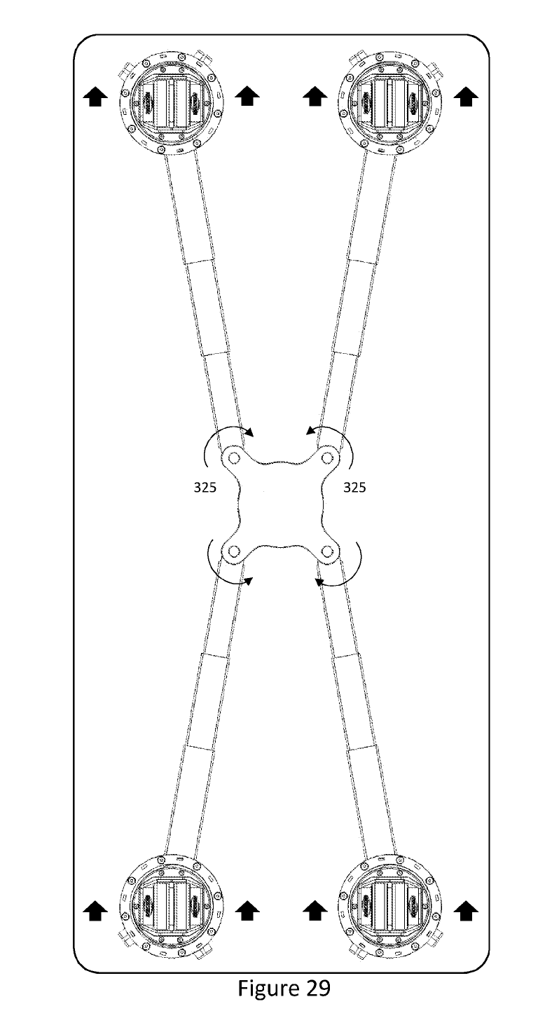

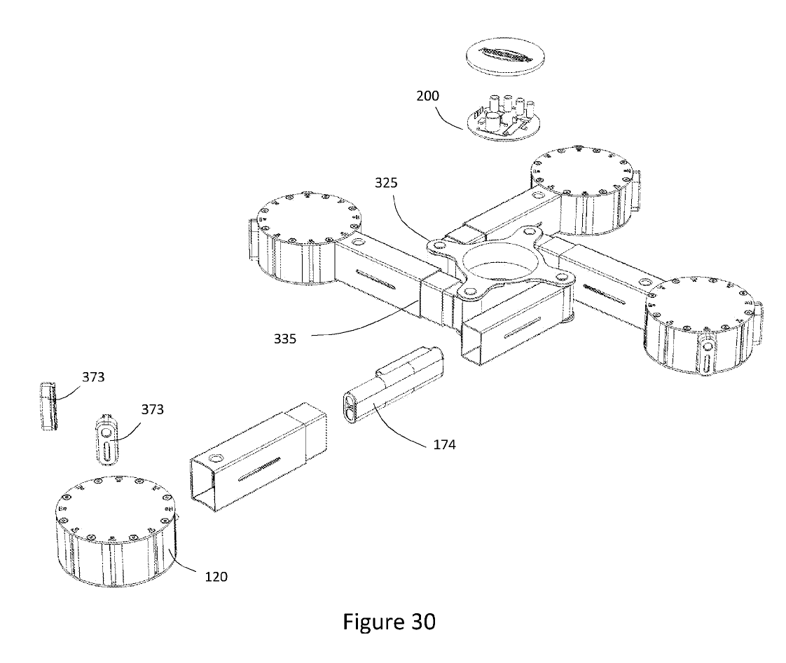

Each time the unit turns, it slightly lifts or lowers the drive housing relative to the ground, as turning the drive assembly in the drive housing is what also causes the vertical displacement between the two. In most applications this slight vertical movement will be of no consequence. In a preferred embodiment, the pitch of the threads is 5 mm and so a 90 degree turn for example will result in a vertical lifting or lowering of 1.25 mm. However a smaller thread pitch will result in slower lifting or lowering, but it will also result in less vertical displacement when turning. For example a 2 mm thread pitch will result in just a ½ mm of lifting/lowering with each 90 degree turn.

This also means it will be harder to turn in one direction compared to the other, however this is relatively straightforward to compensate for in two ways:—
When a load is first engaged and lifted, the amp draw provides an indication of the weight of the load—more amps, more weight, then scale accordingly and calibrate based on known weights. This amp bias can then be a constant for moving that load and a % increase in amps to the motors can be built in so that more amps will be applied to the motors when turning in the direction that lifts the load and less amps will be provided when turning in the direction that lowers the load.
The motors will need to have “closed loop” control. Sometimes referred to as “velocity drive” control. This is a system analogous to cruise control on a car and in this case closed loop control means the controller constantly reads the rpm of the motor, compares it to the desired rpm and adjusts the delivery of the power to the motor to move closer to that desired rpm. Turning therefore can be predictable in either direction with closed loop motor control, however the amp delivery will be higher when turning in the direction where the load is lifted than in the opposing direction where the load is lowered.

FIG. 6 is a partially sectioned view of a dual drive wheel 3DD unit specifically showing the Vertical Displacement Sensor 128 and the Position Actuator 152. The Vertical Displacement Sensor 128 can be an adhesive-backed flexible membrane potentiometer that is adhered into an appropriately shaped pocket in the non-rotating Drive Housing Assembly 130. As the Drive Wheel Assembly 210 rotates relative to the Drive Housing Assembly 130, it moves vertically up or down. The Slip Ring Assembly 150 moves up and down with the Drive Wheel Assembly 210, but the Upper Housing 151 does not rotate with it. The Position Actuator 152 is therefore housed in a horizontal orientation in the Upper Housing 151, the spring-loaded ball at its end scribing a path over the Vertical Displacement Sensor 128. This provides the analog input to the controller of the precise vertical displacement between the Drive Wheel Assembly 210 and the Drive Housing Assembly 130.

FIG. 7 is a partially sectioned view of a dual drive wheel 3DD unit specifically showing the Angular Position Sensor 154 and the Position Actuator 152. The Angular Position Sensor 154 can be an adhesive-backed flexible membrane potentiometer that is adhered into an appropriately shaped pocket in the non-rotating Upper Housing 151 of the Slip Ring Assembly 150. The Position Actuator 152 is therefore housed in a vertical orientation in the Upper Drive Wheel Cap 212 and therefore rotates with it, the spring-loaded ball at its end scribing a path over the the Angular Position Sensor 154. This provides the analog input to the controller of the precise angular orientation of the Drive Wheel Assembly 210 relative to the Drive Housing Assembly 130.

FIGS. 8-10 show how the pivoting drive wheel assembly works to maintain constant contact with the ground and the reasons for this feature are explained.

FIG. 8 is a partially sectioned view of a dual drive wheel 3DD unit located on a gradient. The 3DD unit is remaining horizontal but the floor (in the contact area) is in this hypothetical case is a gradient, so angled.

FIG. 9 is the 3DD of FIG. 8 now showing a reorientation of the drive unit—perhaps for reasons of turning or perhaps for reasons of lifting or lowering. As the two driven wheels are offset from the mid-point vertical axis that exists between the wheels, which is also the axis for the rotation of the Drive Wheel Assembly 210, it is important that both wheels always maintain contact with the ground, for traction.

If for example one wheel makes contact with the ground but the other wheel has either no contact or only partial contact, this will result in undesired and possibly unpredictable locomotion and/or orientation of the drive assembly. The Chassis Pivot Pin 228 allows the drive wheel assembly to pivot smoothly as the assembly rotates to greatly improve the likelihood of both wheels maintaining contact with the ground over uneven surfaces. Note that the pivoting chassis will not however be a complete or perfect solution as loss of traction on one or both (both being very unusual) of the drive wheels will occasionally occur. To address the discrepancy between the calculated orientation of the drive wheel assembly and its height (relative to the drive housing assembly) and what it actually is (per the measured height and orientation using data from the Vertical Displacement Sensor 128 and the Angular Position Sensor 154), the calculated and real values will be constantly compared and adjustments can be made by the main computer 200 accordingly.

FIG. 10 shows the partially sectioned view of FIG. 8 shown from the front, perpendicular to the pivot axis and illustrating the pivoting of the Drive Wheel Assembly 210 relative to the Drive Housing Assembly 130. The extent of tilting possible is limited by the Base Ring Pivot Stops 242, which prevents the pivoting of the Drive Wheel Chassis 220 beyond that contact point.

FIG. 11 shows a high-level explosion of the major assemblies of the complete, Dual Drive Wheels Version of 3DD 120. At the top is the non-rotating Drive Housing Assembly 130, below that is the Slip Ring Assembly 150, and at the bottom of the page is the Drive Wheel Assembly 210.

FIG. 12 shows a more detailed explosion of the non-rotating Drive Housing Assembly 130. At the top is 60, Top Cover, which is fastened with Top Cover Fasteners 61 into the tube holes 72 that are a feature of Drive Housing Outer Tubing 70. Stacked inside the Drive Housing Outer Tubing 70 are one or more Drive Housing Inner Sleeves 133 which are retained vertically by the Bottom Cover, also fastened by Bottom Cover Fasteners 91 into the same tube holes 72 of the Drive Housing Outer Tubing 70. The Housing Inner Sleeves 133 are also retained rotationally within and by vertically by the Drive Housing Outer Tubing 70, which has features that mate with opposing features in the Housing Inner Sleeves 133. Also mounted into the Drive Housing Outer Tubing 70 is a Vertical Displacement Sensor 128, which can be for example an adhesive-backed flexible membrane potentiometer. (An actuator for this sensor is mounted in the Upper non-rotating housing of the Slip Ring Assembly 150 that engages with the potentiometer to provide the height position reading). Lastly, power, earth/ground and data (including sensor data from the hall effect sensors in the motors, the vertical displacement sensor 128 and the angular rotary sensor 154) are represented by the cable Power and Data/Signal Cable 104 that enters through the outer wall of the Drive Housing Outer Tubing 70 and feeds up inside it through an empty chamber in the wall to the upper (non-rotating) Housing of the Slip Ring Assembly.

FIG. 13 shows a more detailed explosion of the Slip Ring Assembly. The purpose of the slip ring is to provide power, signal/data and earth/ground from the machine (from the motor controllers, the main computer, etc.) to the non-rotating Drive Housing and then maintain uninterrupted connection with the rotating drive wheel assembly. The slip ring shown consists of an Upper (non-rotating) Housing 151 that houses the Position Actuator 152 (that travels up and down with the Slip Ring Assembly 150) and in contacting with the Vertical Displacement Sensor/Potentiometer, provides an uninterrupted signal that indicates the height of the 3DD. An Angular position sensor/potentiometer such as an adhesive-backed flexible ring membrane potentiometer is mounted to the underside of the Upper Slip Ring Housing 151. Around the center walled cavity of the Upper Slip Ring Housing 151 are the Upper (non-rotating) power/data rings 156 which are constrained in the Upper Slip Ring Housing 151 by features in that part. The rings 156 can be made from thin copper rings that have a terminal connection point on the upper side that protrudes through the Upper Slip Ring Housing 151 when assembled and to which each wire is attached. An equivalent set of Lower (rotating) power/data rings 157 are similarly housed in the same plane as the upper rings in the Lower (rotating) Housing 158 such that that they are in extremely close proximity to the upper rings and considering the diameter will always make physical contact with the rings at some point(s) about their perimeter. Thus, regardless of position or motion, each ring will maintain multiple connection points with its paired ring even while one set is non-rotating and the other set are rotating, as they are housed together in close (approx. 0.1 mm clearance) proximity.

FIG. 14 shows a more detailed explosion of the Drive Wheel Assembly, 210. At the top of the assembly is the Upper Drive Wheel Cap, 212. It is threaded on its outer perimeter to engage with the mating threads on the inner perimeter of the Drive Housing Inner Sleeves 133. Sandwiched between the Upper Drive Wheel Cap 212 and Drive Wheel Bumper Ring 240 is the Drive Wheel Chassis 220 which contains the Drive Assembly 230. The Chassis consists of the Center Chassis Support Plate 222 which supports the center output shafts of the Drive Gearboxes 234. It also supports at either end the Chassis Pivot Pin 228 which is what allows the entire Drive Wheel Assembly 210 to pivot inside of the holes either end of the Upper Drive Wheel Cap 212 and Drive Wheel Bumper Ring 240 between which it is sandwiched. Side Chassis Support Plates 224 are fastened to either side of the Center Chassis Support Plate 222 that connect to the End Chassis Connecting Plates 226 front and rear of the assembly, using End Chassis Fasteners 227. The Drive Assembly 230 is a dual drive design with all components mirrored about the Center Chassis Support Plate 222. The Drive Motors 236 are bolted to the Side Chassis Support Plates 224, via the Side Chassis Motor Fasteners 225. The motors are mounted onto the input shaft of the Drive Gearboxes 234 which then have mounted about their perimeter the Drive Wheels 232. These Drive Wheels 232 are typically polyurethane tread bonded to a sleeve that is removably attached to the outer cylindrical housing of the gearboxes. All the assemblies are then mounted together via a set of Drive Bumper Fasteners 244 that connect the Drive Wheel Bumper Ring 240 to the Upper Drive Wheel Cap 212, capturing the Chassis Pivot Pin 228 in between.

Located on the Drive Wheel Bumper Ring 240 are two Drive Bumper Pivot Stops that limit the total amount of pivoting that the central Drive Wheel Chassis 220 can do. FIGS. 15-20 describe the adjustable lift height feature of the 3DD. This involves extending the height of both the Drive Housing Assembly 130 (by an increment of one Drive Housing Inner Sleeve 133) and increasing the height of the Drive Wheel Assembly 210 (by the same increment of height). In the preferred embodiment, each Drive Housing Inner Sleeve 133 is 15 mm high and in the below Figures we compare a standard ‘minimum height’ 3DD with a ‘one additional sleeve’ 3DD and a ‘2 additional sleeves’ 3DD.

FIG. 15 shows the minimum height 3DD with 5 of Housing Inner Sleeves 133 and no Drive Wheel Extension Ring 250 in the Drive Wheel Assembly 210. This provides the 3DD with a collapsed height of 90 mm which equates to a clearance when passing under a cart or pallet or other object to be moved.

FIG. 16 shows the 3DD of FIG. 15 in its fully raised configuration. From fully lowered to fully raised the Drive Wheel Assembly 210 will make 9 complete 360 degree revolutions, each revolution raising it 5 mm and so effecting a total lift of 45 mm. This brings the total height of the 3DD to 135 mm.

FIG. 17 shows the adjustable lift height feature with a single ring increment. So now there are 6 of Housing Inner Sleeves 133 and 1 of the Drive Wheel Extension Ring 250 added, in-between the Upper Drive Wheel Cap 212 and the Drive Wheel Base Ring 240. This increases the extended 3DD's collapsed height to 105 mm which equates to a clearance when passing under whatever object is to be moved.

FIG. 18 shows the 3DD of FIG. 17 in its fully raised configuration. From fully lowered to fully raised the Drive Wheel Assembly 210 will make 12 complete 360 degree revolutions, each revolution raising it 5 mm and so effecting a total lift of 60 mm. This brings the total height of the 3DD to 160 mm.

FIG. 19 shows the adjustable lift height feature with a two ring increment. So now there are 7 of Housing Inner Sleeves 133 and 2 of the Drive Wheel Extension Ring 250 added, again in-between the Upper Drive Wheel Cap 212 and the Drive Wheel Base Ring 240. This increases the extended 3DD's collapsed height to 120 mm which equates to a clearance passing under whatever object is to be moved.

FIG. 20 shows the 3DD of FIG. 19 in its fully raised configuration. From fully lowered to fully raised the Drive Wheel Assembly 210 will make 15 complete 360 degree revolutions, each revolution raising it 5 mm and so effecting a total lift of 75 mm. This brings the total height of the 3DD to 190 mm.

A differential drive is not the only way to effect the turning that is required to engage the threads of the 3DD and elicit the vertical travel desired for material handling applications. It is also possible to use a single driven wheel in the Drive Wheel Assembly and at the same time increase the size and power of that wheel to compensate for the fact that there is not a second drive wheel also pushing a load. With a single drive wheel a second drive source is required to turn the Drive Wheel Assembly relative to the Drive Housing and through the thread engagement exert a lifting force. FIGS. 21 and 22 briefly describe a design where one or more geared motors could be housed in up to four locations around the main drive wheel, those engaging with the Drive Housing to effect the turning motion. FIGS. 23, 24 and 25 briefly describe an alternative design where one or more geared motors are located outside the Drive Housing and can engage with the Drive Wheel assembly through a gap in the Drive Housing. A third variation on this concept would be where an external (to the Drive Housing) drive source rotates the Drive Housing, rather than the Drive Wheel Assembly so that the thread engagement will drive the Drive Wheel Assembly down. This is the equivalent to the other systems that drive the Drive Housing up. (This is analogous to turning a threaded rod to move a nut captured on it vs. rotating a nut on a threaded rod to drive the threaded rod axially back and forth in the nut).

FIG. 21 shows an alternative version of 3DD where instead of using a differential drive (meaning two drive wheels 232 that can be driven independently) to effect turning and therefore lifting and lowering, there is a single drive wheel 40 for locomotion. In this embodiment there are then additional turning motor(s) 100, the number of motors according to the loads that need to be lifted, that are housed inside the drive wheel assembly 50 and whose output gears 102 have teeth that engage with corresponding gear teeth 82 in the drive housing sleeve 80. Increasing the number of gear motor 100 can be optimal for greater loads or greater desired rotational forces. Actuating these motor(s) 100 changes the orientation of the drive wheel 40 relative to the drive housing 70. As shown in FIG. 19, drive wheel 40 is comprised of an axle 42 which is constrained by hub body 54 and a drive motor 41. Drive motor 41 can be any type, but the preferred embodiment of the present invention utilizes a hub style motor mounted within drive wheel 40. Drive motor 41 causes drive wheel 40 to rotate and cause the drive unit 10 to move in that direction. Gear motor 100 is fastened to hub body 54 and preferably gear motor 100 is a DC motor and includes a rotary encoder for providing positional feedback. Also preferably, gear motor 100 includes gear reducers so that large rotational forces can be created with optimal rotational speeds. Motor sizing and selection is common in the art of electronics. Gear motor 100 is powered and controlled via a cable 103. Gear 102 is constrained to the output shaft of gear motor 100. A tube housing 70 is preferably constructed from extruded aluminum and cut to the desired height, but can be constructed in any material suitable for the desired load conditions. Tube housing 70 can be made in any diameter or height, suitable for a particular application. Tube housing 70 has an array of internal tube grooves 71 for engaging with a corresponding array of outside sleeve grooves 81 of a sleeve 80. The engagement of tube grooves 71 and sleeve grooves 81 keeps sleeve 80 from rotating with respect to tube housing 70 and transfers loads between. Sleeve grooves 81 provide the means to transfer large forces in shear.

FIG. 22 shows an exploded view of this 3DD Unit with a single driven wheel and internal rotation motor(s). A top cover 60 has an array of top cover fasteners 61 which thread into an array of tube holes 72 of tube housing 70. Secured top cover 60 keeps sleeve 80 from sliding vertically. A bottom cover 90 has an array of bottom cover fasteners 91 which also fasten to tube holes 72. Combined, bottom cover 90, top cover 60, internal grooves 71 and sleeve grooves 81 constrain sleeve 80 to tube housing 70. A mounting bracket 30 provides the means to secure drive unit 10 to external members. Mounting bracket 30 is secured to housing assembly 20 through the use of at least one of a top cover slot 62, at least one of a bottom cover slot 92, and a plurality of capture ridges 73 of housing 70. As shown, there may be any number of capture ridges 73 around housing 70 allowing bracket 30 to provide a wide range of attachment configurations and positions. Drive unit 10 can have a plurality of brackets 30 mounted for a particular application. Bracket 30 may have threaded holes as shown, or can have studs supporting other common attachment methods. Attached to top cover 60 is a power slip ring assembly 150 which allows power and signal cables to be fixed to housing assembly 60 but also maintain electronic contact with rotatable hub assembly 50. Conductive rings of slip ring 24 in contact with spring contacts of hub assembly 50 (not shown) maintain electrical pathways in any orientation of hub assembly 50 with respect to housing assembly 20. Slip rings are common in the art of power transmission and robotic control. Hub assembly 50 is comprised of at least one gear motor 100, at least one corresponding gear 102, a hub body 54, and a drive wheel 40.

FIG. 23 shows another alternative version of single drive wheel 3DD where the motor that elicits the turning is housed externally to the drive wheel assembly that is being turned. Note that while gears and gear teeth are shown as the means of engaging with and turning the drive wheel assembly, it should be appreciated that various other means of drive transfer could be applied such as chain and sprocket drive transfer, belt and pulley drive transfer, friction drive transfer or others.

FIG. 24 shows another perspective view from below of the same single drive wheel 3DD of FIG. 24 where the motor that elicits the turning is housed external to the drive wheel assembly, but in this case viewed from below and with the 3DD assembly collapsed to its lowest height.

FIG. 25 shows another perspective view from below of the same 3DD of FIG. 25, but in this case with the 3DD assembly extended to its highest height.

FIGS. 26-30 illustrate the application of 3DD's in systems for common material handling applications. To show some of the unique capabilities of this device when multiple units are used, ‘morphable’ cart movers are shown and described. Note that as each 3DD contains all the functionality to move, turn and lift and lower, much of the complexity in designing the machines is eliminated and the machines really just become a means to connect multiple 3DD units. However, beyond this broad generalization, it should be noted that the versatility of the 3DD units also provides some additional functional features that would otherwise be very complicated to include.

The basic premise is that pivots 335 (to change the shape of portions of a 3DD system) and slides 325, also known as telescoping extenders/retractors (that change the size of portions of a 3DD system) can be easily accommodated. An interesting feature of a 3DD based system is that the structure connecting the 3DD's does not need to be particularly strong, as it does not encounter any significant forces, even when heavy carts are being moved. The reason is that once the 3DD's rise up and engage with the load being moved, the load itself takes the role of connecting the 3DD's together. Provided the connection against each 3DD is secure and does not slide, the only structural purpose served by the arms and linkages is to prevent the 3DD units from tilting off horizontal. The load itself however also helps to do this and certainly keeps the units evenly spaced and connected.

There are many simple ways to improve the security of the connection between each 3DD and the load being moved. One is to have conical shaped pins on either the underside of the cart or the top side of the 3DD cart mover. Then holes in the opposing cart or 3DD system that will be mated with it will help ensure a binding connection that will only allow release when the 3DD unit is lowered.

FIGS. 26-30 will help illustrate by way of examples.

FIG. 26 is a perspective view from above of a generic, four-armed cart mover, each arm able to pivot off the central chassis and able to telescope to extend further out from that central chassis. The central chassis houses the Main Computer 200 that is the high-level controller for the system while the arms house the battery cells and two-channel output motor controllers that power each 3DD motor. In this view the system is mostly contracted to its smallest footprint but still capable of moving unhindered.

FIG. 27 shows the same cart moving system from FIG. 26, this time viewed from directly below so that the orientation of the Drive Wheel Assemblies 210 of each 3DD is visible. In this view, it can be seen that the system can move in any direction when all wheels are oriented the same way. Further, though not shown, the wheels can all be oriented perpendicular to the center point of the system and therefore rotate about its own central axis. Alternatively the wheels can be oriented in any direction as required which will result in some combination of extending, rotating, turning or morphing into a different shape.

FIG. 28 shows the same cart moving system from FIG. 26, this time with the Drive Wheel Assemblies all pointed out from the center and driving away from the center axis of the system. This has the effect of extending the arms and increasing the size of the 3DD system. In this hypothetical example, the same 3DD system of FIG. 26 that could move a small square cart, maintaining a stable connection by picking up near the 4 corners of the cart, could easily morph into a larger shape to engage with a significantly larger cart.

FIG. 29 shows the same cart moving system from FIG. 26, this time with the Drive Wheel Assemblies having all oriented perpendicular from the center chassis to pivot into new positions, changing the shape of the 3DD system, in this case to engage with a long, rectangular footprint load. So in this hypothetical example, the same 3DD system of FIG. 26 that could move a small square cart, or of FIG. 28 that could move a large square cart, could now morph into a large rectangular shape to maintain a stable connection with such a cart by picking up near the 4 corners of the cart.

FIG. 30 shows the generic 3DD system of FIG. 26 somewhat disassembled to show the basic components, being the 3DD units 120, connecting arms that can telescope 335 or pivot 325. In the center chassis can be located the Main Computer 200 and in the connecting arms can be located the battery packs 174 and dual channel output motor controllers (not shown). At the end of each arm and attached to the 3DD units 120 could be sensors that help the unit navigate in a facility.

### Glossary of Components

120 3DD Unit Complete, Dual Drive Wheels Version.
   130 Drive Housing Assembly, Dual Drive Wheels Version.
      30 Attachment Bracket
      60 Top Cover
      61 Top Cover Fasteners
      73 Capture Slots for Attachment Bracket
      104 Power and Data/Signal Cable
      133 Drive Housing Inner Sleeve
      128 Vertical displacement sensor/potentiometer
      70 Drive Housing Outer Tubing
         72 Tube Holes
      90 Bottom Cover
      91 Bottom Cover Fasteners
   150 Slip Ring Assembly.
      151 Upper (non-rotating) Housing
      152 Position Actuator
      154 Angular position sensor/potentiometer
      156 Upper (non-rotating) power/data rings
      157 Lower (rotating) power/data rings
      158 Lower (rotating) Housing
   210 Drive Wheel Assembly, Dual Drive Wheels Version.
      212 Upper Drive Wheel Cap
      220 Drive Wheel Chassis
         222 Center Chassis Support Plate
         224 Side Chassis Support Plate
         225 Side Chassis Motor Fasteners
         226 End Chassis Connecting Plate
         227 End Chassis Fasteners
         228 Chassis Pivot Block
      230 Drive Wheel(s) Assembly
         232 Drive Wheel
         234 Drive Gearbox
         236 Drive Motor
         237 Drive Motor Cover
      240 Drive Wheel Base Ring
         242 Base Ring Pivot Stops
         244 Base Ring Fasteners
      250 Drive Wheel Extension Ring (Optional)
      373 Sensors (for navigation)
      174 Battery Packs
      325 System Pivot Arm
      335 System Extendable Telescoping Arm
      195 Motor Controller
      200 System Controller (Main Computer)
10 3DD Unit Complete, Single Drive/Internal Rotation Version.
   20 Drive Housing Assembly, Single Drive/Internal Rotation Version.
      60 Top Cover
      61 Top Cover Fasteners
      104 Power and Data/Signal Cable
      80 Drive Housing Inner Sleeve
      81 Ridges on Outer Surface (for constraining rotationally in Housing Tubing)
      82 Gear Engagement Features on Inner Surface (for turning)
      83 Screw Thread Engagement Features on Inner Surface (for Lifting)
      128 Vertical Displacement Sensor/Potentiometer
      70 Drive Housing Outer Tubing
         72 Tube Holes
      90 Bottom Cover
      91 Bottom Cover Fasteners
      100 Gear Motor
      102 Gear Sprocket
      103 Cable
   150 Slip Ring Assembly.
      151 Upper (non-rotating) Housing
      152 Position Actuator
      154 Angular Position Sensor/Potentiometer
      156 Upper (non-rotating) power/data rings
      157 Lower (rotating) power/data rings
      158 Lower (rotating) Housing
   300 Drive Wheel Assembly, Single Drive/Internal Rotation Version.
      54 Drive Wheel Hub Body
      230 Drive Wheel(s) Assembly
         40 Drive Wheel(s)
         41 Drive Motor
         42 Drive Axle
         237 Drive Motor Cover
      240 Drive Wheel Base Ring
         242 Base Ring Pivot Stops
         244 Base Ring Fasteners

1. A 3D drive unit (120) comprising:
a cylindrical non-rotating housing assembly (130)
a slip ring assembly (150)
a cylindrical rotating drive assembly (210)
one independently driven wheel or set of wheels (40) or two independently driven wheels or sets of wheels (232)
wherein the drive wheel assembly is supported in a cylindrical drive sleeve, together forming a drive assembly that is itself supported, but able to rotate within, a cylindrical housing assembly.

2. The 3D drive unit according to the previous claim wherein the outer surface of the drive assembly and the inner surface of the housing assembly engage with each other and the rotation of the drive assembly relative to the housing assembly result in one being displaced vertically relative to the other.

3. The 3D drive unit according to any of the preceding claims wherein the outer surface of the drive assembly and the inner surface of the housing assembly are mating screw threads.

4. The 3D drive unit according to any of the preceding claims where the screw threads of the Drive Housing Inner Sleeve (133) or the Upper Drive Wheel Cap (212) are made from an injection molded plastic material.

5. The 3D drive unit according to any of the preceding claims where the Drive Housing Outer Tubing (70) is injection molded plastic material or extruded aluminum.

6. The 3D drive unit according to any of the preceding claims wherein one or more additional drive sources, such as motors or motors with gearing are housed within the drive assembly and interact with the inner surface of the housing assembly to rotate the housing assembly relative to the drive assembly, providing a turning effect on the drive assembly.

7. The 3D drive unit according to any of claims 1 to 4 wherein one or more additional drive sources, such as motors or motors with gearing are housed outside the housing assembly and interact with the outer surface of the drive assembly to rotate the drive assembly relative to the housing assembly, providing a turning effect on the drive assembly.

8. The 3D drive unit according to any of the preceding claims wherein the drive wheel assembly has a horizontal pivot in which one or more drive wheels can pivot in a plane perpendicular to the central vertical axis of the drive assembly to accommodate variations in floor height or gradient.

9. The 3D drive unit according to any of the preceding claims comprising at least one sensor for measuring the vertical displacement between the drive assembly and housing assembly, adjust the power delivered to the motors and achieve the desired drive assembly orientation or desired amount of lifting or lowering of the housing assembly relative to the drive assembly.

10. The 3D drive unit according to any of the preceding claims comprising at least one sensor to measure the radial orientation of the drive assembly relative to the housing assembly, adjust the power delivered to the motors and achieve the desired drive assembly orientation or desired amount of lifting or lowering of the housing assembly relative to the drive assembly.

11. The 3D drive unit according to any of the preceding claims comprising additional internally threaded housing rings that can be added to extend the height of the housing, along with additional externally threaded rings that can be added to extend the height of the drive assembly, and together provide additional increments of vertical displacement of the housing assembly related to the drive assembly.

12. The 3D drive unit according to any of the preceding claims wherein the drive assembly comprises two independently driven wheels that are displaced either side of a central vertical pivot axis and that by driving each at different speeds elicits a turning moment on the drive assembly and thus reorients the drive assembly relative to the housing assembly in which it is housed.

13. A load moving machine or system comprising one or more 3D drive units as disclosed in any one of the previous claims that are connected together.

14. A load moving machine or system according to the previous claim wherein 3D drive units as disclosed in any of the claims 1 to 12 are attached to intermediary components or directly to each other with brackets that are themselves connectable to the 3D drive units.

15. A load moving machine or system according to claim 13 or 14 wherein connecting arms or linkages can telescope or otherwise retract or extend to change the displacement distance between any two 3D drive units.

16. A load moving machine or system according to claims 13 to 15 wherein connecting arms or linkages can pivot or otherwise change the angular or positional relationship between any two 3D drive units.

17. Use of any 3D drive unit as described in claims 1 to 12 or any of load moving machines or systems in claims 13 to 16 for robotic or non-robotic transportation of materials such as pallets, paper rolls, cable reels, vehicles, carts, etc.
